(19) United States
(12) Patent Application Publication
(10) Pub. No.: US 2012/0176639 A1
(43) Pub. Date: Jul. 12, 2012

(54) INTERNET PRINTING SYSTEM AND METHOD

(75) Inventor: Teng-Yu Tsai, New Taipei (TW)

(73) Assignee: HON HAI PRECISION INDUSTRY CO., LTD., New Taipei (TW)

(21) Appl. No.: 13/215,643

(22) Filed: Aug. 23, 2011

(30) Foreign Application Priority Data
Jan. 10, 2011 (TW) 100100759

(51) Int. Cl. G06F 3/12; G06F 15/00

(52) U.S. Cl. 358/1.14; 358/1.15

(57) ABSTRACT

An Internet printing system includes a server computer for maintaining information concerning printers that are registered in the server computer and a client computer for accessing the server computer over the Internet. The server computer provides the client computer with a list of registered printers when responding to a printing request from the client computer. The server computer determines a target printer from among the list of registered printers according to a selection of the client computer. The server computer accepts a print job from the client computer, and then sends the print job to the target printer to print the document.

### BACKGROUND

1. Technical Field

The disclosure generally relates to an Internet printing system and an Internet printing method.

2. Description of Related Art

Many printers are primarily used as local peripherals, and are attached by a printer cable or, in most newer printers, a USB cable to a computer which serves as a document source. Alternatively, some printers may be coupled to the computer via a LAN network. In either case, the computer needs a printer driver to communicate with the desired printer. However, printer drivers are dependent on hardware platforms and/or OS platforms. If the printer driver of a printer is not available for the specific hardware platform and/or the specific OS platform of the computer, the computer is not able to use that printer. For example, almost no printer vendors develop printer drivers for a smart phone, which uses ARM architecture and ANDROID™ OS. That causes a problem in that a number of computing devices are not able to print because of no driver support. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of an Internet printing system.

FIG. 2 is a schematic diagram of one embodiment of a computer suitable for use in implementing the Internet printing system.

FIG. 3 illustrates a sequence diagram of an exemplary embodiment of an Internet printing method.

FIG. 4 is an operational flow diagram representing an exemplary embodiment of a method of a server computer for processing data from a client computer.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

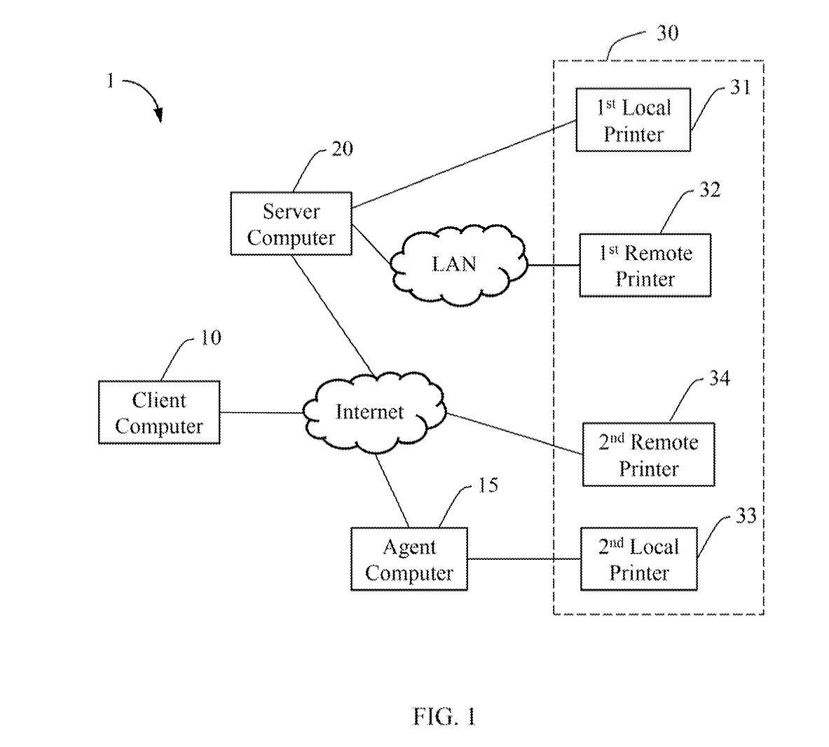

FIG. 1 is a schematic diagram of one embodiment of an Internet printing system 1. The Internet printing system 1 may include a client computer 10, a server computer 20, and one or more printers, such as a first local printer 31, a first remote printer 32, a second local printer 33, and a second remote printer 34, collectively designated by a reference numeral 30. Both the client computer 10 and the server computer 20 may be a general purpose computing device which includes at least a processing unit, a storage unit and a network interface.

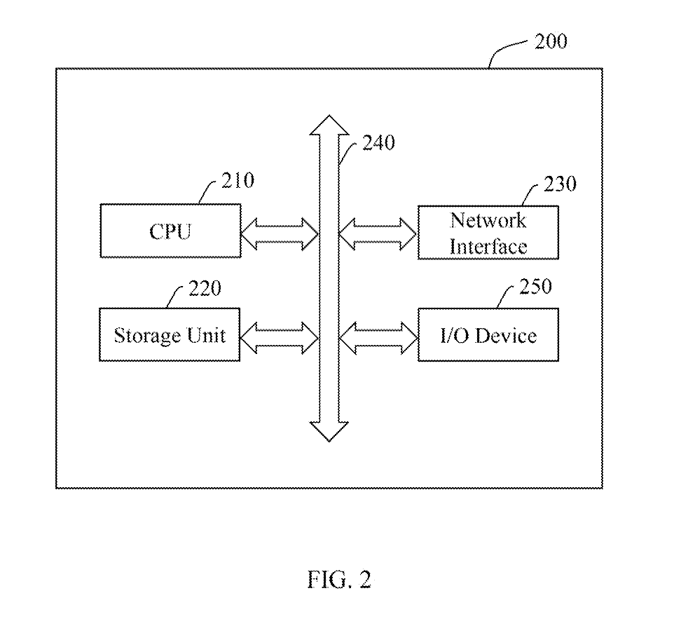

With reference with FIG. 2, a general purpose computing device in the form of a computer 200 is shown. The components of the computer 200 may include, but are not limited to, a central processing unit (CPU) 210, a storage unit 220, a network interface 230, and a system bus 240 that couples various components to the processing unit 210. The system bus 240 may be any of several types of bus structures including a memory bus or a memory controller, a peripheral bus, and a local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnect (PCI) bus (also known as the Mezzanine bus).

The storage unit 220 may be any form of volatile or non-volatile storage, including, for example, RAM, ROM, EPROM, flash memory, a magnetic disk such as an internal hard disk or a removable disk, an optical disk such as a CD-ROM, or any other storage which can be used to store the desired information and which can be accessed by the computer 200. The storage unit 220 may store machine-executable instructions, data, and various programs, such as an operating system and one or more application programs, all of which may be processed by the CPU 210.

The computer 200 may include one or more input/output (I/O) devices 250 such as a display, a keyboard, a mouse, or other pointing device. The I/O device 250 may be connected to the CPU 210 through the system bus 240.

The computer 200 may operate in a network environment using logical connection to one or more remote computers through the network interface 230. The logical connection may be through a local area network (LAN) or a wide area network (WAN) such as the Internet. The network interface 230 may be a network adapter card using a specific physical layer and a data link layer standard such as Ethernet or Wi-Fi. When used in a WAN networking environment, the computer 200 typically includes a modem or other means for establishing communications over the WAN, such as the Internet.

As mentioned, the computer 200 described above can be deployed as either the client computer 10 or as the server computer 20.

In the Internet printing system 1, the one or more printers 30 and the configuration of each may be registered in the server computer 20. The registered information may include at least an Internet protocol (IP) address, or a hostname of each of the one or more the printers 30 plus basic information such as the printer make, model, and serial number.

The one or more printers 30 may be coupled to the server computer 20 in a variety of ways. In FIG. 1, a first local printer 31 is physically and directly attached to the server computer 20 by a printer cable such as a USB cable. A first remote printer 32 is coupled to the server computer 20 via a LAN. A second remote printer 33 is coupled to the server computer 20 via the Internet. Both the first remote printer 32 and the second remote printer 33 are referred to as network printers, with a built-in network interface, typically wireless and/or Ethernet based. A second local printer 34 without a built-in network interface is coupled to the server computer 20 via an agent computer 15 that functions as a network interface between the second local printer 34 and the Internet.

The server computer 20 may include access identification information for registered users. Each registered user may be associated with one or more registered printers to which the registered user has printing permission access. The access identification information includes at least one of a user name, a password and an email address for identifying a target registered user. The server computer 20 may determine a list of registered printers to which a registered user may have printing permission access, according to the access identification information of the registered user.

The client computer 10 may submit a printing request and access identification information to the server computer 20 via the Internet. When the server computer 20 authenticates the access identification information and sends a list of registered printers based on the access identification information to the client computer 10, the client computer 10 may select a preferred or target registered printer and create a print job accordingly. The print job may include a document or a uniform resource locator (URL) specifying a document, which needs to be printed.

When the server computer 20 receives a print job from the client computer 10, the server computer 20 can associate the print job with the preferred or target registered printer, which has been selected by the client computer. The server computer 20 may convert the print job to a format compatible with the preferred or target registered printer according to the registration and configuration information of the preferred or target registered printer. If the print job includes a URL specifying the document, the server computer 20 may download the document according to its URL. The server computer 20 may transmit the print job to the preferred or target registered printer. The preferred or target registered printer may perform the print job and print the desired document.

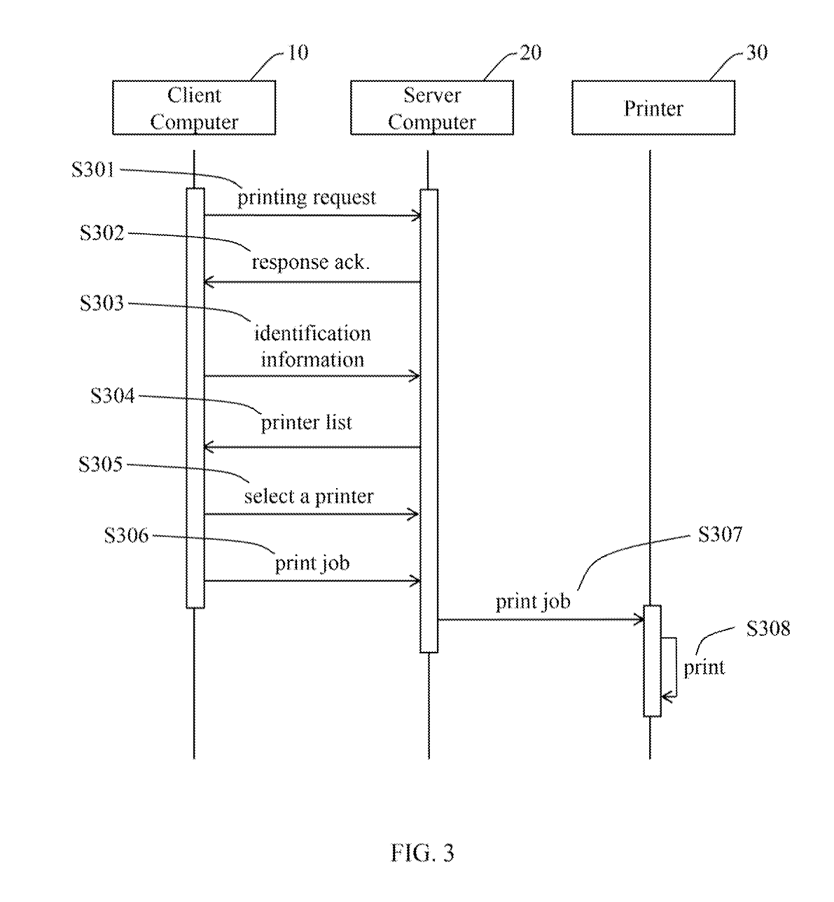

FIG. 3 illustrates a sequence diagram of an embodiment of an Internet printing method. The method may include the following steps.

In step S301, the client computer 10 submits a printing request to the server computer 20.

In step S302, the server computer 20 sends a response acknowledging the printing request to the client computer 10.

In step S303, the client computer 10 submits access identification information to the server computer 20.

In step S304, the server computer 20 authenticates the access identification information and determines a list of registered printers based on the access identification information. Then the server computer 20 sends the list of registered printers to the client computer 10.

In step S305, the client computer 10 selects a preferred or target registered printer from among the list of registered printers.

In step S306, the client computer 10 creates a print job to the server computer 20.

In step S307, the server computer 20 converts the print job to a format compatible with the preferred or target registered printer according to the corresponding registration and configuration information of the printer, and sends the print job to the printer.

In step S308, the printer performs the print job.

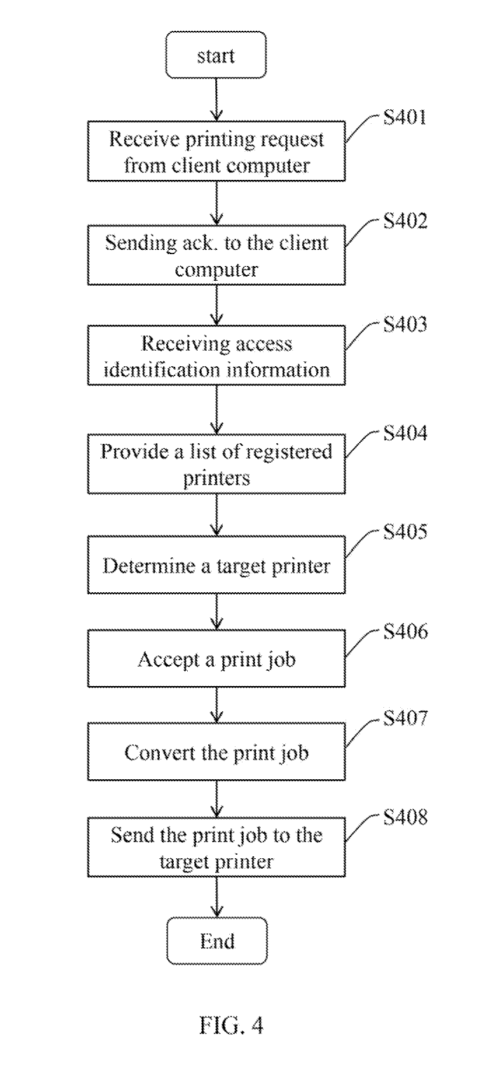

FIG. 4 is a flowchart illustrating one embodiment of a method of a server computer for processing data from a client computer. The method may include the following steps.

In step S401, the server computer 20 receives a printing request from the client computer 10.

In step S402, the server computer 20 sends an acknowledgement of the printing request to the client computer 10.

In step S403, the server computer 20 receives access identification information from the client computer 10 and authenticates the access identification information.

In step S404, the server computer 20 determines a list of registered printers based on the access identification information and sends the list of registered printers to the client computer 10.

In step S405, the server computer 20 determines a target registered printer from among the list of registered printers according to a selection of the client computer 10.

In step S406, the server computer 20 accepts a print job requesting for printing a document from the client computer 10.

In step S407, the server computer 20 converts the print job to a format compatible with the target registered printer according to the corresponding registration and configuration information of the target registered printer.

In step S408, the server computer 20 sends the print job to the target registered printer to print the desired document.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and the arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the descriptions and the claims drawn for or in relation to a method may include some indication in reference to certain steps. However, any indication used is only to be viewed for identification purposes and not as a suggestion as to an order for the steps.

What is claimed is:

1. A computer-implement method executed by a server computer for processing data from a client computer via the Internet, the method comprising:
receiving a printing request from the client computer;
providing the client computer a list of registered printers that are registered in the server computer;
determining a target printer from among the list of registered printers according to a selection of the client computer;
accepting a print job requesting to print a document from the client computer; and
sending the print job to the target printer to print the document.

2. The method of claim 1, further comprising converting the print job to a format compatible with the target printer.

3. The method of claim 1, further comprising receiving access identification information from the client computer.

4. The method of claim 3, wherein the access identification information comprises at least one of a user name, a password and an email address for identifying a target user.

5. The method of claim 3, further comprising determining the list of registered printers to which the client computer has printing permission access based on the access identification information.

6. The method of claim 1, wherein the print job comprises the document.

7. The method of claim 1, wherein the print job comprises a uniform resource locator (URL) which specifies the document.

8. A server computer for processing data from a client computer, the server computer being accessible to the client computer via the Internet, the server computer comprising:
a storage unit adapted to store information of registered printers that are registered in the server computer;
a processing unit adapted to receive a printing request from the client computer, provide the client computer a list of registered printers, determine a target printer from among the list of registered printers according to a selection of the client computer, accept a print job requesting to print a document from the client computer, and send the print job to the target printer to print the document.

9. The server computer of claim 8, wherein the processing unit is further adapted to convert the print job to a format compatible with the target printer.

10. The server computer of claim 8, wherein the processing unit is further adapted to receive access identification information from the client computer.

11. The server computer of claim 10, wherein the access identification information comprises at least one of a user name, a password and an email address for identifying a target user.

12. The server computer of claim 10, wherein the processing unit is further adapted to determine the list of registered printers to which the client computer has printing permission access based on the access identification information.

13. The server computer of claim 8, wherein the print job comprises the document.

14. The server computer of claim 8, wherein the print job comprises a uniform resource locator (URL) which specifies the document.

15. An Internet printing system comprising:
a server computer accessible over the internet for maintaining information of registered printers that are registered in the server computer;
a client computer for accessing the server computer over the Internet;
wherein the server computer is adapted to provide the client computer a list of registered printers responding to a printing request from the client computer, determine a target printer from among the list of registered printers according to a selection of the client computer, accept a print job requesting to print a document from the client computer, and send the print job to the target printer to print the document.

16. The system of claim 15, wherein the server computer is further adapted to convert the print job to a format compatible with the target printer.

17. The system of claim 15, wherein the server computer is further adapted to receive access identification information from the client computer.

18. The system of claim 17, wherein the access identification information comprises at least one of a user name, a password and an email address for identifying a target user.

19. The system of claim 17, wherein the server computer is adapted to determine the list of registered printers to which the client computer has printing permission access based on the access identification information.

20. The system of claim 15, wherein the print job comprises a uniform resource locator (URL) which specifies the document.
